(19) United States
(12) Patent Application Publication
(10) Pub. No.: US 2009/0036587 A1
(43) Pub. Date: Feb. 5, 2009

(54) Propylene Resin Composition With Flame Retardance And Abrasion Resistance

(75) Inventors: Do-Hoon Chang, Seoul (KR); June-Sun Kim, Gyeonggi-do (KR); In-Hwoi Lee, Seoul (KR); Gun-Ju Lee, Seoul (KR); In-Ha Kim, Seoul (KR); Sun-Keun Kim, Seoul (KR)

Correspondence Address: STROOCK & STROOCK & LAVAN LLP, 180 MAIDEN LANE, NEW YORK, NY, 10038, US

(73) Assignee: LS CABLE LTD., Gyeonggi-do (KR)

(21) Appl. No.: 12/280,462

(22) PCT Filed: Feb. 16, 2007
(86) PCT No.: PCT/KR2007/000840

§ 371 Date: Sep. 18, 2008

(30) Foreign Application Priority Data
Feb. 22, 2006 (KR) 10-2006-0017388
Feb. 15, 2007 (KR) 10-2007-0015732

(51) Int. Cl. C08K 3/22

(52) U.S. Cl. 524/436

(57) ABSTRACT

Disclosed is a polypropylene resin composition with flame retardance and abrasion resistance. The polypropylene resin composition according to the present invention includes 20 to 200 parts by weight of an inorganic flame retardant; and 0.1 to 10 parts by weight of at least one additive, based on 100 parts by weight of a base resin comprising 30 to 90% by weight of polypropylene copolymer resin and 10 to 70% by weight of polyolefin alpha copolymer resin. The polypropylene resin composition according to the present invention can be used for industrial cables with potent endurance since it includes an inorganic flame retardant to show flame retardance and it can remove or reduce a whitening phenomenon and show a significantly improved abrasion resistance without deteriorating moldability or mechanical property even when the contents of the composition are varied to enhance abrasion resistance.

### TECHNICAL FIELD

The present invention relates to a polypropylene resin composition with flame retardance and abrasion resistance, and more particularly to a polypropylene resin composition with flame retardance and abrasion resistance capable of suppressing a whitening phenomenon since a resin obtained by blending a polypropylene copolymer resin and a polyolefin alpha copolymer resin is used as a base resin and a suitable inorganic flame retardant is added to the composition.

### BACKGROUND ART

Generally, a large amount of magnesium hydroxide or an inorganic filler was added to a polypropylene resin to manufacture a resin composition with high flame retardance. However, the complex resin prepared thus has significantly low physical properties such as moldability and mechanical properties, and therefore it is difficult to apply to the field of cables requiring a more than certain level of tensile strength or elongation, etc.

In order to solve the above problems, a method for introducing an elastomer portion to a matrix resin composition was presented. In order to solve the whitening-related problems, a method for introducing a polar group into an elastomer portion of an inorganic flame retardant to surround the elastomer portion was also presented. However, the introduction of a polar group into an elastomer portion results in deterioration, rather than improvement, of mechanical properties, and also in insufficient improvement of a whitening phenomenon and difficulty in ensuring abrasion resistance.

In order to manufacture products having flame retardance, as well as potent abrasion resistance and excellent physical properties without causing almost no whitening phenomenon, there have been unsatisfactory attempts to develop a polypropylene resin composition in the related art. There have been continuous attempts to solve the above technical problems, and therefore the present invention is designed on the basis of the above-mentioned facts.

### DISCLOSURE OF INVENTION

### Technical Problem

Accordingly, the present invention is designed to develop a complex polypropylene resin composition which may ensure abrasion resistance and minimize a whitening phenomenon, as well as a polypropylene resin composition with flame retardance, and therefore it is an object of the present invention to provide a polypropylene resin composition with flame retardance and abrasion resistance.

### Technical Solution

In order to accomplish the above object, one embodiment of the present invention provides a polypropylene resin composition with flame retardance and abrasion resistance including 20 to 200 parts by weight of an inorganic flame retardant which is magnesium hydroxide or aluminium hydroxide; and 0.1 to 10 parts by weight of at least one additive selected from the group consisting of an antioxidant, a processing aid, a copper antioxidant and a halogen scavanger, based on 100 parts by weight of a base resin comprising 30 to 90% by weight of polypropylene copolymer resin and 10 to 70% by weight of polyolefin alpha copolymer resin.

Also, another embodiment of the present invention provides a polypropylene resin composition with flame retardance and abrasion resistance including 20 to 200 parts by weight of an inorganic flame retardant which is magnesium hydroxide or aluminium hydroxide; and 0.1 to 10 parts by weight of at least one additive selected from the group consisting of an antioxidant, a processing aid, a copper antioxidant and a halogen scavanger, based on 100 parts by weight of a base resin comprising 30 to 89% by weight of polypropylene copolymer resin, 10 to 70% by weight of polyolefin alpha copolymer resin and 1 to 20% by weight of modified polypropylene resin. At this time, a modified polypropylene constituting the base resin is preferably at least one polypropylene resin grafted with a compound containing a polar group selected from the group consisting of maleic anhydride, silane and fatty acid.

In the above-mentioned polypropylene resin composition with flame retardance and abrasion resistance, the polypropylene copolymer resin constituting the base resin is preferably at least one polypropylene-based resin selected from the group consisting of homo polymer polypropylene, random copolymer polypropylene and block polymer polypropylene, the polyolefin alpha copolymer resin constituting the base resin is preferably propylene-α-olefin copolymer resin, the propylene-α-olefin copolymer resin is more preferably at least one copolymer resin selected from the group consisting of polypropylene-octane and polypropylene-butene, and the inorganic flame retardant is preferably a pure inorganic flame retardant without surface treatment, or an inorganic flame retardant surface-treated with one material selected from the group consisting of vinyl silane, amino silane, stearic acid and polymers.

### BEST MODE FOR CARRYING OUT THE INVENTION

Hereinafter, preferred embodiments of the present invention will be described for better understanding, and described in detail referring to the accompanying drawings, if necessary. However, the description proposed herein is just a preferable example for the purpose of illustrations only, not intended to limit the scope of the invention, so it should be understood that other equivalents and modifications could be made thereto without departing from the spirit and scope of the invention. Therefore, preferred embodiments of the present invention is provided to those skilled in the art from this detailed description.

The polypropylene resin composition with flame retardance and abrasion resistance according to one embodiment of the present invention includes a base resin obtained by blending a polypropylene copolymer resin and a polyolefin alpha copolymer resin; an inorganic flame retardant which is magnesium hydroxide; and at least one additive selected from the group consisting of an antioxidant, a processing aid, a copper antioxidant and a halogen scavanger.

The polypropylene resin composition with flame retardance and abrasion resistance according to another embodiment of the present invention includes a base resin composed of a polypropylene copolymer resin, a polyolefin alpha copolymer resin and a modified polypropylene resin; an inorganic flame retardant which is magnesium hydroxide or aluminium hydroxide; and at least one additive selected from the group consisting of an antioxidant, a processing aid, a copper antioxidant and a halogen scavanger. At this time, the modified polypropylene constituting the base resin is preferably at least one polypropylene resin grafted with a compound containing a polar group selected from the group consisting of maleic anhydride, silane and fatty acid.

Heat resistance of the composition is deteriorated if the content of the polypropylene copolymer resin constituting the base resin is less than the lower numerical limit, while flame retardance and flexibility of the composition are deteriorated and a whitening phenomenon is also severely affected if the content exceeds the upper numerical limit. The polypropylene copolymer resin constituting the base resin is preferably at least one polypropylene-based resin selected from the group consisting of homo polymer polypropylene, random copolymer polypropylene and block polymer polypropylene. Various kinds of the polypropylene resins may be used here, but random polypropylene is the most preferred for the potent purpose of reducing or removing a whitening phenomenon.

Meanwhile, in order to improve mechanical properties such as tensile strength and elongation of the polypropylene-based copolymer resin and reduce a whitening phenomenon, a base resin is prepared by mixing and blending a polyolefin alpha copolymer resin. Elongation, filler loadiness and cold resistance are deteriorated and a whitening phenomenon is increased if the content of the polyolefin alpha copolymer resin is less than the lower numerical limit, while heat resistance, tensile strength, harness property, abrasion resistance and the like are deteriorated if the content exceeds the upper numerical limit. The polypropylene alpha copolymer resin is preferably a propylene-α-olefin copolymer, and the propylene-α-olefin copolymer is more preferably at least one copolymer selected from the group consisting of polypropylene-octane and polypropylene-butene. It is apparent to those skilled in the art that the polypropylene alpha copolymer resin is selected in consideration of compatability of the polypropylene resin used as the base resin.

Flame retardance is deteriorated if the content of the magnesium hydroxide or aluminium hydroxide used as the inorganic flame retardant is less than the lower numerical limit, while mechanical properties are deteriorated if the content exceeds the upper numerical limit. The inorganic flame retardant including magnesium hydroxide or aluminium hydroxide may be directly used as a pure inorganic flame retardant without surface treatment, or used as an inorganic flame retardant surface-treated with one material selected from the group consisting of vinyl silane, amino silane, stearic acid and polymers.

In the following Table 1, the compositions were divided into the compositions of Embodiments 1-1 to 1-4 prepared respectively by blending two components (A+B) and the compositions of the Embodiments 2-1 to 2-4 prepared respectively by blending three components (A+B+C). Also, the compositions of Comparative examples are prepared respectively as a control corresponding to the compositions of the Embodiments. The compositions were prepared on the basis of the components and their contents as listed in the following Tables 1 and 2, respectively.

TABLE 1

| | Embodiments | | | | | | | |
|---|---|---|---|---|---|---|---|---|
| | 1-1 | 1-2 | 1-3 | 1-4 | 2-1 | 2-2 | 2-3 | 2-4 |
| A | 30 | 50 | 70 | 90 | 30 | 47.5 | 65 | 70 |
| B | 70 | 50 | 30 | 10 | 69 | 47.5 | 25 | 10 |
| C | — | — | — | — | 1 | 5 | 10 | 20 |
| D | 150 | 150 | 150 | 150 | 150 | 150 | 150 | 150 |
| E | 3 | 3 | 3 | 3 | 3 | 3 | 3 | 3 |

TABLE 2

| | Comparative examples | | | | |
|---|---|---|---|---|---|
| | 1-1 | 1-2 | 2-1 | 2-2 | 2-3 |
| A | 20 | 95 | 100 | 50 | 70 |
| B | 80 | 5 | — | — | — |
| C | — | — | — | 50 | 30 |
| D | 150 | 150 | 150 | 150 | 150 |
| E | 3 | 3 | 3 | 3 | 3 |

In the Tables 1 and 2, Component A represents R724J from LG-Caltex (Korea) which is used as the polypropylene random copolymer resin which is a polypropylene-based copolymer resin, Component B represents Tafmer from Mitsui Chemicals (Japan) which is used as the polyethylene alpha propylene which is a polyolefin alpha copolymer resin, Component D represents Magnifin H5 from Albemarle (German) which is used as the magnesium hydroxide which is an inorganic flame retardant, and Component E represents other additives such as an antioxidant.

In the Table 1, Component C represents CM1120 from Honam Petrochemical Corp. (Korea) which is used as the modified polypropylene, and, in the Table 2, Component F represents Engage 8150 from DuPont-Dow Elastomer (USA) which is used as the polyolefin elastomer resin.

The compositions having the components of Embodiments and Comparative examples as listed in Tables 1 and 2 were used to prepare test samples, respectively, and then the test samples were measured for a tensile property, a whitening phenomenon at bending strain and an abrasion resistance. The results are listed in the following Table 3.

The measurement samples prepared according to ASTM D 638 were measured for tensile properties such as tensile strength and elongation using a universal testing machine. In order to measure a whitening phenomenon at bending strain, the presence of the whitening phenomenon was observed with the naked eye when an insulating material for cable was actually blended under the conditions of a resin thickness of 1□ and a bending radius of 5□. In order to measure a whitening phenomenon under the same conditions as described above, each of the compositions was extrusion-molded to prepare a test sample having a thickness of 1□, and then a cylindrical sample having a diameter of 2 mm was prepared at a bending radius of 5□. The resultant samples were tested at the same bending radius to observe the presence of whitening phenomenon with the naked eye. The abrasion resistance was measured using a needle scraper test in which a thickness of an abraded test sample is measured when 710 g of a poise was put on a 0.45 sq needle and the needle moves back and forth 300 times on the 2 mm wide×1□ thick×100□ long test sample.

TABLE 3

| | Embodiments | | | | | | | | Comparative examples | | | | |
|---|---|---|---|---|---|---|---|---|---|---|---|---|---|
| | 1-1 | 1-2 | 1-3 | 1-4 | 2-1 | 2-2 | 2-3 | 2-4 | 1-1 | 1-2 | 2-1 | 2-2 | 2-3 |
| Tensile | 11 | 15 | 22 | 28 | 12 | 18 | 24 | 28 | 8 | 32 | 38 | 8 | 10 |
| strength | | | | | | | | | | | | | |
| (MPa) | | | | | | | | | | | | | |
| Elongation | 1,000 | 800 | 500 | 170 | 950 | 680 | 340 | 150 | 1,300 | 90 | 70 | 400 | 100 |
| (%) | | | | | | | | | | | | | |
| Whitening | No | No | Slight | Slight | No | No | Slight | Slight | No | High | Very | High | High |
| | | | | | | | | | | | High | | |
| Abrasion | 47 | 18 | 5 | 1 | 41 | 12 | 4 | 1 | 58 | 1 | 0 | 31 | 19 |
| resistance | | | | | | | | | | | | | |
| (□) | | | | | | | | | | | | | |

As seen in the Table 3, it was revealed that the whitening phenomenon appears slightly or does not appear in the case of the Embodiments, but the whitening phenomenon appears in the case of the other Comparative examples except for the Comparative example 1-1, and, particularly, the whitening phenomenon appears in a very high degree in the case of the Comparative example 2-1. Accordingly, it was seen that the compositions of the Comparative examples have a bending strain which is more fragile than that of the Embodiments. Considering that the abrasion resistance is evaluated to be proper if a measured reference value of the abrasion resistance is less than 50□, it was confirmed that the whitening phenomenon does not appear but the abrasion resistance appears in the lowest degree and particularly fragile if the abrasion resistance exceeds the reference value.

Meanwhile, the compositions were divided into the compositions including a 4-component base resin according to Embodiments 3-1 to 3-5, as listed in the following Table 4, and the compositions according to Comparative examples 3-1 to 3-6 were divided as listed in the following Table 5. Then, each of the compositions was prepared according to the components and their contents as listed in the following Tables 4 and 5.

TABLE 4

| | Embodiments | | | | |
|---|---|---|---|---|---|
| | 3-1 | 3-2 | 3-3 | 3-4 | 3-5 |
| G | 10 | 24 | 20 | 25 | 50 |
| H | 3 | 4 | 6 | 8 | 5 |
| I | 9 | 24 | 11 | 4 | 5 |
| J | 5 | 10 | 20 | 30 | 5 |
| K | 70 | 35 | 40 | 30 | 30 |
| L | 3 | 3 | 3 | 3 | 5 |

TABLE 5

Comparative examples

| | 3-1 | 3-2 | 3-3 | 3-4 | 3-5 | 3-6 |
|---|---|---|---|---|---|---|
| G | 20 | 22.5 | 25 | 25 | 40 | 35 |
| M | 20 | 17.5 | 20 | 10 | — | 5 |
| K | 60 | 60 | 55 | 65 | 60 | 60 |

In the Table 4 and 5, Component G represents R724J from LG-Caltex (Korea) which is used as the polypropylene random copolymer resin, Component H represents CM1120 from Honam Petrochemical Corp. (Korea) which is used as the modified polypropylene, Component I represents Tafmer from Mitsui Chemicals (Japan) which is used as the polypropylene copolymer resin, Component J represents Fusabond MN 493D from DuPont (USA) which is used as the maleic anhydride grafted polyolefin copolymer resin, Component K represents Magnifin H5 from Albemarle (German) which is used as the magnesium hydroxide, and Component L represents other additives such as an antioxidant.

In the Table 5, Component M represents Engage 8150 from DuPont-Dow Elastomer (USA) which is used as the polyolefin elastomer resin.

The compositions having the components of Embodiments and Comparative examples as listed in Tables 4 and 5 were used to prepare test samples, respectively, and then the test samples were measured for a tensile property, a whitening phenomenon at bending strain and an abrasion resistance. The results are listed in the following Table 6.

The measurement samples prepared according to ASTM D 638 were measured for tensile properties such as tensile strength and elongation using a universal testing machine. In order to measure a whitening phenomenon at bending strain, the presence of the whitening phenomenon was observed with the naked eye when an insulating material for cable was actually blended under the conditions of a resin thickness of 1□ and a bending radius of 5□. In order to measure a whitening phenomenon under the same conditions as described above, each of the compositions was extrusion-molded to prepare a test sample having a thickness of 1□, and then a cylindrical sample having a diameter of 2 mm was prepared at a bending radius of 5□. The resultant samples were tested at the same bending radius to observe the presence of whitening phenomenon with the naked eye. The abrasion resistance was measured using a needle scraper test in which a thickness of an abraded test sample is measured when 710 g of a poise was put on a 0.45 sq needle and the needle moves back and forth 300 times on the 2 mm wide×1□ thick×100□ long test sample.

TABLE 6

| | Embodiments | | | | | Comparative examples | | | | | |
|---|---|---|---|---|---|---|---|---|---|---|---|
| | 3-1 | 3-2 | 3-3 | 3-4 | 3-5 | 3-1 | 3-2 | 3-3 | 3-4 | 3-5 | 3-6 |
| Tensile | 9.6 | 15.7 | 22.8 | 25.4 | 12.0 | 10.1 | 10.6 | 11.5 | 12.8 | 8.2 | 9.3 |
| strength | | | | | | | | | | | |
| (MPa) | | | | | | | | | | | |
| Elongation | 124 | 540 | 423 | 247 | 352 | 246 | 244 | 221 | 196 | 10 | 44 |
| (%) | | | | | | | | | | | |
| Whitening | Slight | No | | | Slight | High | | | | | |
| Abrasion | 32 | 18 | 14 | 9 | 5 | 97 | 85 | 79 | 71 | 58 | 68 |
| resistance | | | | | | | | | | | |
| (□) | | | | | | | | | | | |

As seen in the Table 6, it was revealed that the whitening phenomenon appears slightly in the case of the Embodiments 3-1 and 3-5 and does not appear in the case of the other Embodiments 3-2 to 3-4. On the contrary, it was revealed that the whitening phenomenon appears in the case of all the Comparative examples 3-1 to 3-6, indicating that the compositions of the Comparative examples are fragile to the bending strain. Meanwhile, it was revealed that the compositions of in all the Embodiments (3-1 to 3-5) have a significantly improved abrasion resistance, compared to that of all the Comparative examples (3-1 to 3-6). It was shown that the more lowered the abrasion resistance becomes, the more excellent the abrasion resistance becomes. Generally, the abrasion resistance is considered to be proper if a reference value of the measured abrasion resistance is less than 50 □.

As described above, the present invention has been described in detail. However, it should be understood that the terms used in the specification and appended claims are just given by way of detailed illustration only, so it should be understood that other equivalents and modifications could be made thereto without departing from the spirit and scope of the invention.

### INDUSTRIAL APPLICABILITY

As described above, the polypropylene resin composition according to the present invention can be used for industrial cables with potent endurance since it includes an inorganic flame retardant to show flame retardance and it can remove or reduce a whitening phenomenon and show a significantly improved abrasion resistance without deteriorating moldability or mechanical property even when the contents of the composition are varied to enhance abrasion resistance.

1. (canceled)

2. (canceled)

3. A polypropylene resin composition with flame retardance and abrasion resistance,
wherein a base resin is constituted including:
5 to 70% by weight of polypropylene resin;
0.5 to 10% by weight of modified polypropylene;
1 to 50% by weight of polyolefin alpha copolymer resin; and
1 to 30% by weight of modified polyolefin copolymer resin,
wherein the composition comprises;
10 to 75% by weight of an inorganic flame retardant which is magnesium hydroxide; and
1 to 5 parts by weight of at least one additive selected from the group consisting of an antioxidant, a processing aid, a copper antioxidant and a halogen scavanger.

4. The polypropylene resin composition with flame retardance and abrasion resistance according to any one of claims 3,
wherein the polypropylene copolymer resin constituting the base resin is at least one polypropylene-based resin selected from the group consisting of homo polymer polypropylene, random copolymer polypropylene and block polymer polypropylene.

5. The polypropylene resin composition with flame retardance and abrasion resistance according to any one of claims 3,
wherein the polyolefin alpha copolymer resin constituting the base resin is propylene-α-olefin copolymer resin.

6. The polypropylene resin composition with flame retardance and abrasion resistance according to claim 5,
wherein the propylene-α-olefin copolymer resin is at least one copolymer, resin selected from the group consisting of polypropylene-octane and polypropylene-butene.

7. The polypropylene resin composition with flame retardance and abrasion resistance according to any one of claims 3,
wherein the inorganic flame retardant is a pure inorganic flame retardant without surface treatment, or an inorganic flame retardant surface-treated with one material selected from the group consisting of vinyl silane, amino silane, stearic acid and polymers.

8. The polypropylene resin composition with flame retardance and abrasion resistance according to claim 3,
wherein the modified polypropylene constituting a base resin is at least one polypropylene resin grafted with a compound containing a polar group selected from the group consisting of maleic anhydride, silane and fatty acid.

9. The polypropylene resin composition with flame retardance and abrasion resistance according to claim 3,
wherein the modified polyolefin copolymer resin is a polarized material obtained by introducing a polar molecule into a thermoplastic elastomer.

10. The polypropylene resin composition with flame retardance and abrasion resistance according to claim 9,
wherein the material introduced to polarize the thermoplastic elastomer is at least one compound containing a polar group selected from the group consisting of maleic anhydride, silane and fatty acid.
